(19) United States
(12) Patent Application Publication
(10) Pub. No.: US 2024/0286270 A1
(43) Pub. Date: Aug. 29, 2024

(54) BACKLASH-FREE AXLE BEARING FOR GANTRY SYSTEMS

(71) Applicant: Jenny Science AG, Rain (CH)

(72) Inventor: Alois Jenny, Rain (CH)

(21) Appl. No.: 18/587,585

(22) Filed: Feb. 26, 2024

(30) Foreign Application Priority Data
Feb. 26, 2023 (DE) 10 2023 104 658.6

(51) Int. Cl. B25J 5/04

(52) U.S. Cl. CPC B25J 5/04

(57) ABSTRACT

A device for positioning an end effector in a space spanned by a longitudinal direction, a transverse direction and a vertical direction has: a first linear rail aligned in the longitudinal direction and on which a first longitudinal slide is arranged so as to be movable in the longitudinal direction, a second linear rail aligned parallel to the first linear rail in the longitudinal direction and on which a second longitudinal slide is arranged so as to be movable in the longitudinal direction, and a third linear rail guiding a cross slide connected to the first linear slide via a first guide element and to the second linear slide via a second guide element, characterized in that the first guide element is a first spring structure that is rigid in the vertical direction and the second guide element is a second spring structure that is rigid in the vertical direction.

### TECHNICAL FIELD

The present disclosure relates to a device for positioning an end effector in a space which is spanned by a longitudinal direction, by a transverse direction transverse to the longitudinal direction and by a vertical direction transverse to the longitudinal direction and transverse to the transverse direction, where the end effector has a first linear rail which is aligned in the longitudinal direction and on which a first longitudinal slide is arranged so as to be movable in the longitudinal direction, a second linear rail, which is aligned parallel to the first linear rail in the longitudinal direction and on which a second longitudinal slide is arranged so as to be movable in the longitudinal direction, and a third linear rail guiding a cross slide, which is connected to the first linear slide via a first guide element and to the second linear slide via a second guide element.

### SUMMARY

According to one aspect of the disclosure, a device for positioning an end effector in a space which is spanned by a longitudinal direction, by a transverse direction transverse to the longitudinal direction and by a vertical direction transverse to the longitudinal direction and transverse to the transverse direction comprises a first linear rail which is aligned in the longitudinal direction and on which a first longitudinal slide is arranged so as to be movable in the longitudinal direction, a second linear rail aligned parallel to the first linear rail in the longitudinal direction, on which a second longitudinal slide is arranged so as to be movable in the longitudinal direction, and a third linear rail guiding a cross slide, which is connected to the first linear slide via a first guide element and to the second linear slide via a second guide element. According to one aspect of the disclosure, the first guide element is designed as a first spring structure that is rigid in the vertical direction and the second guide element is designed as a second spring structure that is rigid in the vertical direction.

The specified device, which is also known as a gantry system, is based on the idea that the first and second guide elements are necessary because the arrangement of the three linear rails is mechanically overdetermined and only functions correctly if the first linear rail and the second linear rail are aligned exactly parallel to each other. Otherwise, the third linear rail may jam when moving over the first linear rail and the second linear rail. Due to disruptive environmental influences such as thermal expansion, this risk can never be completely avoided and must be taken into account mechanically.

The device mentioned at the beginning solves this problem by means of guide elements in the form of longitudinal sliding bearings. Such longitudinal sliding bearings reduce the risk of jamming of the third linear rail, but if the mechanical misalignment is too great, additional guide elements such as rotary sliding bearings would have to be used. Regardless of which sliding bearings are used, however, the problem of mechanical backlash arises, which increases with each additional bearing introduced. As with the parallel alignment of the first and second linear rails, this can be reduced by ensuring sufficient precision, but it cannot be prevented and results in positioning errors in the vertical direction, for example.

This is where the device comes in with the idea of connecting the third linear rail to the first and second linear rail not via mechanical bearings but via spring elements that are dimensionally stable and therefore rigid, at least in the vertical direction. In this way, absolute zero backlash is achieved at least in the vertical direction and positioning errors in the vertical direction are minimized.

In an embodiment of the specified device, the first spring structure is rigid in the longitudinal direction and elastic transversely to the longitudinal direction and the vertical direction. This ensures that the third linear rail is also positioned with zero backlash in the longitudinal direction and only compensates for tolerances in the transverse direction.

In principle, the first spring structure can be of any design as long as it can be arranged rigidly in the vertical direction. For example, any bending springs, such as plate springs, can be considered. In a particular embodiment, the first spring structure comprises a leaf spring as a bending spring, which is arranged parallel to the longitudinal direction and parallel to the vertical direction. In this way, the first guide element can be realized inexpensively, because leaf springs are inexpensive, particularly in comparison to torsional sliding bearings and longitudinal sliding bearings. Furthermore, the installation volume is compact because leaf springs can be integrated into the architecture of the device. Finally, leaf springs are maintenance-free compared to plain or roller bearings because no friction reducing agents or readjustment work is required.

In an additional embodiment of the specified device, the first spring structure comprises a further bending spring connected to the leaf spring in the form of a leaf spring, which is arranged parallel to the leaf spring. In this way, the first spring structure only absorbs movements in the transverse direction and keeps the third linear rail stably aligned in the transverse direction because no movement takes place in the longitudinal direction.

It is particularly preferable for the leaf spring to be a spring plate, which on the one hand enables a backlash-free deflection in the spring direction, but on the other hand offers very high rigidity against tension and compression in the material direction.

In a preferred embodiment of the specified device, the leaf springs comprise a front end and a rear end as viewed in the longitudinal direction, wherein the leaf springs are connected at the front end so as to be bendable towards one another and wherein the first leaf spring is connected at the rear end to the first linear rail and the second leaf spring is connected at the rear end to the third linear rail. In this way, the first spring structure can be built up like an accordion and the elasticity of each individual spring can be utilized over its entire length.

In a particularly preferred embodiment of the specified device, the two leaf springs at the rear end comprise a stop directed towards each other to limit movement in the transverse direction. In this way, it is possible to prevent the leaf springs from overstretching and the risk of unintentional damage to the first spring structure can thus be reduced.

In a further embodiment of the specified device, the two leaf springs are made of the same material and are geometrically identical. In this way, the above-mentioned compensation of tolerances, excluding tolerances in the transverse direction, is achieved in a particularly simple, space-saving and cost-effective manner.

In another embodiment of the specified device, the second spring structure is designed to be elastically torsionable about the vertical direction. This ensures that the third linear rail can rotate in the transverse direction to the second longitudinal slide to compensate for incorrect positioning.

In yet another embodiment, said device comprises a gap extending continuously in the vertical direction between the third linear rail and the second linear slide, said gap being aligned at an entry point in the longitudinal direction and at an exit point in the transverse direction, wherein the torsionable second spring structure comprises at the entry point of the gap a leaf spring aligned in the transverse direction connecting the third linear rail and the second linear slide to each other and at the exit point a leaf spring aligned in the longitudinal direction connecting the third linear rail and the second linear slide to each other. Within this gap, the third linear rail can move freely in a plane spanned by the longitudinal direction and the transverse direction to compensate for tolerances.

In an additional embodiment, the specified device comprises a stop element which is arranged at an angle to the leaf spring aligned in the transverse direction and at an angle to the leaf spring aligned in the longitudinal direction. This stop element, in particular in conjunction with the stop of the first spring structure, ensures a maximum permissible length of the third linear rail and effectively prevents the overstretching of all leaf springs involved in the specified device.

In a further embodiment of the specified device, the stop element is mounted on a support shoulder so that it can slide in the vertical direction. The support shoulder prevents the stop element from being incorrectly positioned in space and thus further increases the reliability of the specified device.

### BRIEF DESCRIPTION OF FIGURES

The above-described properties, features and advantages of the device disclosed herein, as well as the manner in which they are achieved, will become clearer in connection with the following description of the embodiments, which are explained in more detail in connection with the drawing, in which:

FIG. 1 shows a device called a gantry system in a perspective view,

FIG. 2 shows a first spring structure in the gantry system of FIG. 1 in a perspective view,

FIG. 3 shows a second spring structure in the gantry system of FIG. 1 in a perspective view,

FIG. 4 shows a schematic view of a linear rail in the gantry system of FIG. 1, and

FIG. 5 shows a schematic view of a guide element in the linear rail of FIG. 4.

In the figures, the same technical elements are provided with the same reference signs, and are only described once. The figures are purely schematic and, in particular, do not reflect the actual geometric proportions.

### DETAILED DESCRIPTION

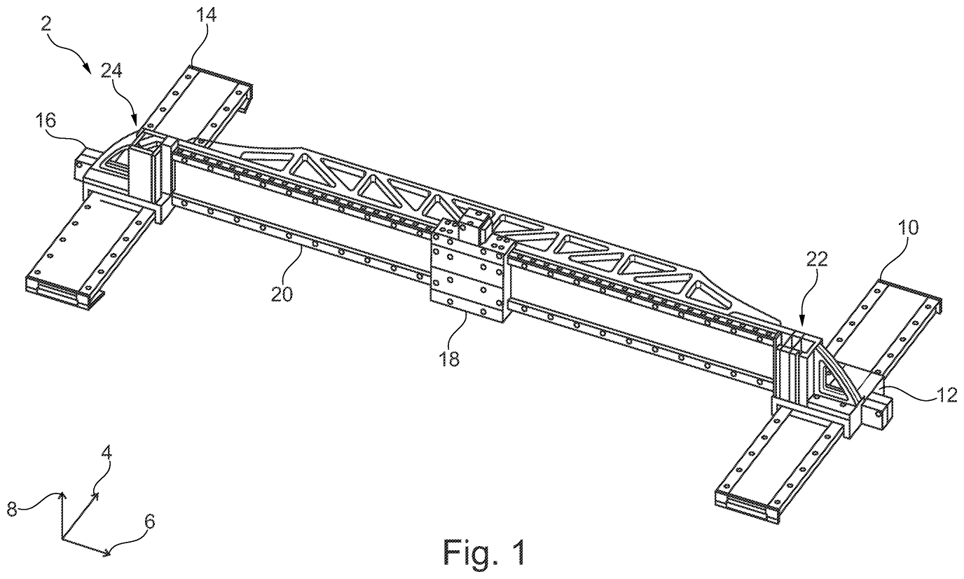

Reference is made to FIG. 1, which shows a device called a gantry system 2 in a perspective view of a space which is spanned by a longitudinal direction 4, a transverse direction 6 transverse to the longitudinal direction 4 and a vertical direction 8, transverse to the longitudinal direction 4 and transverse to the transverse direction 6. The gantry system 2 is to be understood as an electromechanical movement system of a geometric axis aligned in the longitudinal direction 4, in which two separate feed motors not shown further move a common drive axis in the longitudinal direction 4. Both feed motors are operated with angular synchronism. As a result, the gantry system 2 behaves as if it only had a single feed motor.

It can be used to position an end effector, not shown in any further detail, in the space, for example in machine tools. A known application purpose is portal milling machines with a traversing portal (the so-called gantry design), in which the columns supporting the portal can thus be moved absolutely synchronously.

The gantry system 2 comprises a first linear rail 10 aligned in the longitudinal direction 4, on which a first longitudinal slide 12 is arranged so as to be movable in the longitudinal direction 4. Furthermore, the gantry system 2 comprises a second linear rail 14, which is aligned parallel to the first linear rail 10 in the longitudinal direction 4 and on which a second longitudinal slide 16 is arranged so as to be movable in the longitudinal direction 4. Finally, the gantry system also has a third linear rail 20 guiding a cross slide 18, which is connected to the first linear slide 10 via a first guide element 22 and to the second linear slide 14 via a second guide element 24. The end effector, which is not shown further and which can be positioned in space with the gantry system 2, can be arranged on the cross slide 18.

This structure is basically statically overdetermined and is known from U.S. Pat. No. 9,186,763 B2. The purpose of this mechanically and statically rather unfavorable design of the gantry system 2 is to save a considerable amount of space compared to a design with a clamping table that moves a comparable distance in the longitudinal direction 4. Accordingly, the gantry system 2 can be used regularly on machine tools that are designed for machining particularly long workpieces.

The first guide element 22 is designed as a first spring structure and the second guide element 24 as a second spring structure, which are composed of leaf springs in the form of spring plates, for an absolutely backlash-free, cost-effective and maintenance-free design. These spring assemblies are described in more detail below.

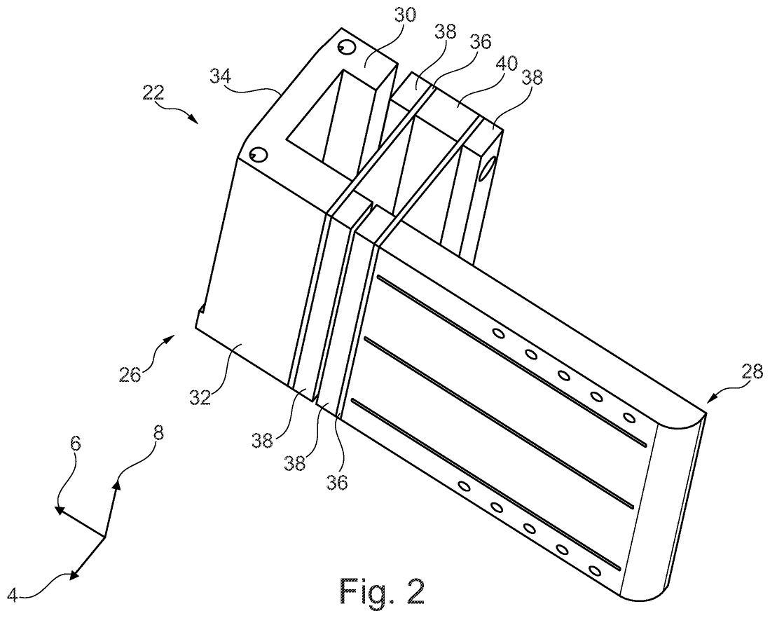

The spring structure of the first guide element 22 is explained in more detail in Appendix FIG. 2.

The first guide element 22 comprises a first longitudinal slide connecting element 26 for connecting the first guide element 22 to the first longitudinal slide 12 and a cross slide connecting element 28 for connecting the first guide element 22 to the cross slide 18.

The first longitudinal slide connecting element 26 has a U-shaped cross-section as seen in the vertical direction 8, wherein the U-section has a first leg 30 and a second leg 32 arranged downstream of the first leg 30 in the longitudinal direction, wherein the legs are connected to each other at their end via a base plate 34 as seen in the transverse direction 6. The first leg 30 is shorter than the second leg 32 when viewed in the direction opposite the transverse direction 6.

A leaf spring in the form of a spring plate 36 extending in the opposite direction to the longitudinal direction 4 is placed on the end of the second leg 32 opposite the base plate 34, as seen in the opposite direction to the transverse direction 6, and is fastened to the second leg 32 on the side opposite the second leg 32 by means of a pressure plate 38.

Viewed in the opposite direction to the longitudinal direction 4, a connecting element 40 is placed on the other end of the spring plate 36 and is fastened in the transverse direction 6 on the opposite side of the spring plate 36 by a further pressure plate 38. A further spring plate 36 is placed on the opposite end of the connecting element 40, as viewed in the opposite direction to the transverse direction 6, and is attached to the connecting element 40 via a further pressure plate 38. Finally, the further spring plate 36 is adjoined at the opposite end, as seen in the longitudinal direction 4, by the cross slide connecting element 28, which is also connected to the further spring plate 36 via a pressure plate 38 on the side of the cross slide connecting element 28 opposite the latter, as seen in the transverse direction 6.

The spring plates 36 are of equal length when viewed in the longitudinal direction 4, so that the cross slide connecting element 28 and the second leg 32 run on a line extending in the transverse direction 6. Due to the parallel arrangement of the spring plates 36, the spring structure of the first guide element 22 can deform elastically in the event of transverse forces in and against the transverse direction 6, but is rigid against longitudinal forces in and against the longitudinal direction 4. If the spring structure of the first guide element 22 yields when absorbing a transverse force in the transverse direction 6, it is compressed in the transverse direction 6 until the pressure plates 38 on the second leg 32 and on the cross slide connecting element 28 meet in or against the transverse direction 6. These pressure plates 38 therefore serve not only to increase frictional locking but also as stops to limit movement in the transverse direction 6.

The background to this structure, which is rigid in the longitudinal direction 4 and elastic in the transverse direction 6, will be discussed in more detail later.

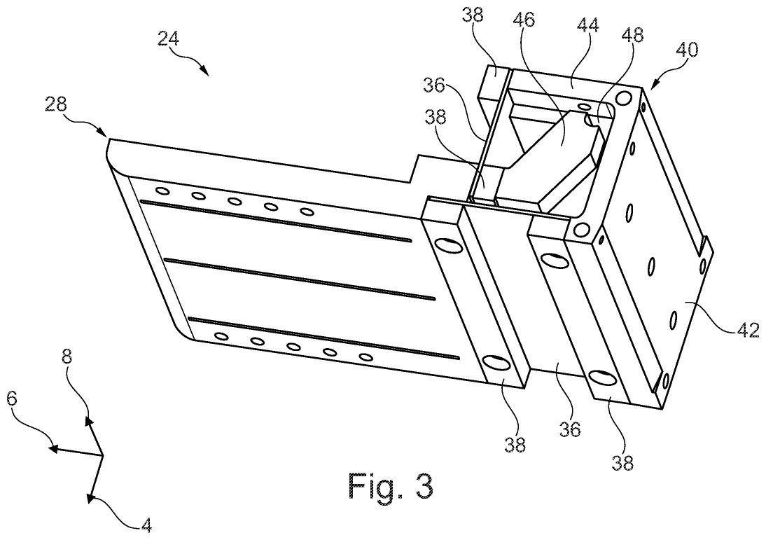

Before that, the spring structure in the second guide element 24 will be explained in more detail with reference to FIG. 3.

The second guide element 24 comprises a second longitudinal slide connecting element 40 for connecting the second guide element 24 to the second longitudinal slide 14 and a cross slide connecting element 28 for connecting the second guide element 24 to the cross slide 18.

The second longitudinal slide connecting element 40 is L-shaped in cross-section as seen in the vertical direction 8, the L-section having a first leg 42 aligned in the longitudinal direction and a second leg 44 aligned in the transverse direction.

A spring plate 36 aligned in the transverse direction 6 is attached to the free end of the first leg 42 via a pressure plate 38, while a spring plate 36 aligned in the longitudinal direction is attached to the free end of the second leg 44 via a pressure plate 38. The opposite sides of the two spring plates 36 run towards each other and are attached to the cross slide connecting element 28 via pressure plates 38. The two spring plates 36 arranged at an angle to each other in this way stiffen the second guide element 24 both in the longitudinal direction 4 and in the transverse direction 6, so that the second guide element 24 is designed to be elastic only for movement caused by torques about the vertical direction 8.

In order to limit these rotational movements, the second guide element 24 has a stop element 46, which is attached to the connection point of the two spring plates 36 and has a free end facing the connection point of the two legs 42, 44. In this way, the stop element 46 contacts one of the legs 42, 44 in the event of excessive rotational movements, thus preventing overstressing of the spring plates 36. The stop element 48 rests slidingly on a shoulder 48, which is formed on the sides of the legs 42, 44 of the second longitudinal slide connecting element 40 directed towards the spring plates 36.

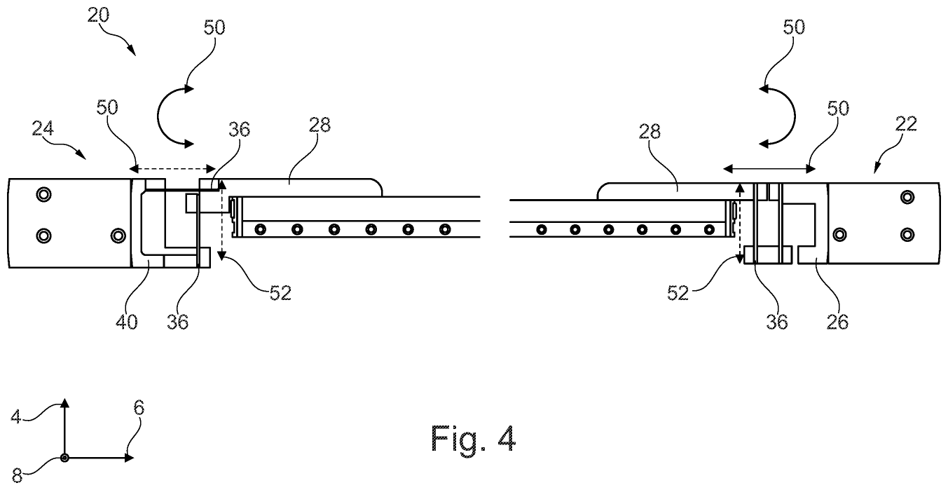

The effect of the two guide elements 22, 24 will now be explained in more detail with reference to FIG. 4. In the plane spanned by the longitudinal direction 4 and the transverse direction 6, movements 50 elastically permitted by the guide elements 22, 24 are indicated by solid double arrows, while movements 52 blocked by the guide elements 22, 24 are indicated by dotted double arrows. Movements in planes that are parallel to the vertical direction 8 basically block the guide elements 22, 24, so that a corresponding view has been omitted for the sake of brevity.

For the movement of the third linear rail 20 in and against the longitudinal direction 4, an exact parallel alignment of the two other linear rails 10, 14 to each other is required. However, incorrect positioning due to tolerances, thermal movements and the like require a movement compensation of a few hundredths of a millimeter in the transverse direction 6 or of a few angular minutes around the vertical direction. This movement compensation is achieved by the permitted movements 50. All other movements 52 are prevented and therefore cannot result in any backlash into the gantry system 2.

However, the spring plates 36 also ensure that there is absolutely no backlash in the permitted movements 50, because the movement is caused by material deformation in the elastic area of the spring plates 36. The stop elements 38, 46 are provided to prevent the material from leaving this elastic range.

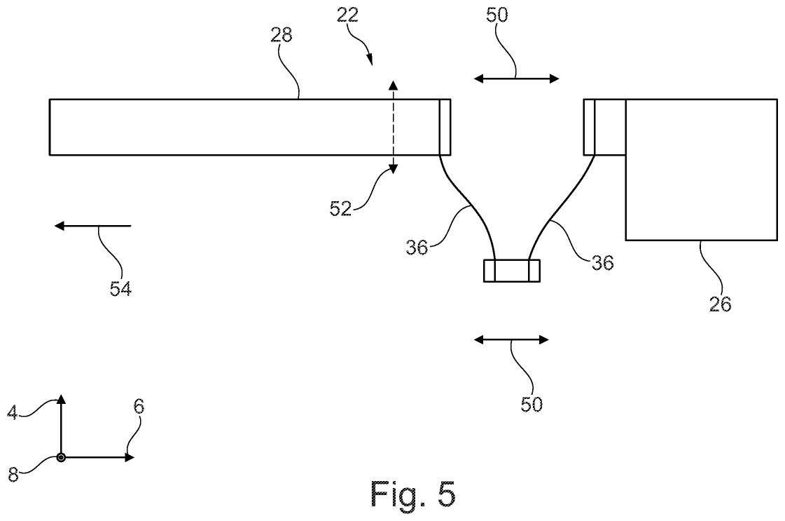

This absolute freedom from backlash is illustrated in FIG. 5, in which an external force 54 acts on the third linear rail 20 connected to the cross slide connecting element 28 due to thermal compensation movements.

The suppression of the other movements 52 is achieved in the simplest way if both spring plates 36 are made of the same material and have the same geometric design, because then the two spring plates deform axially symmetrically to each other.

Since the spring plates 36 are inexpensive to procure, the guide elements 22, 24 can be constructed extremely inexpensively. In addition, the installation volume of the spring plates 36 can be designed flexibly and is compact. The spring plates 36 are also maintenance-free, as no lubrication or other adjustment work is required.

1. Device for positioning an end effector in a space which is spanned by a longitudinal direction, by a transverse direction transverse to the longitudinal direction and by a vertical direction transverse to the longitudinal direction and transverse to the transverse direction, comprising:
a first linear rail which is aligned in the longitudinal direction and on which a first longitudinal slide is arranged so as to be movable in the longitudinal direction,
a second linear rail, which is aligned parallel to the first linear rail in the longitudinal direction and on which a second longitudinal slide is arranged so as to be movable in the longitudinal direction, and
a third linear rail guiding a cross slide, which is connected to the first linear slide via a first guide element and to the second linear slide via a second guide element,
characterized in that the first guide element is designed as a first spring structure that is rigid in the vertical direction and the second guide element is designed as a second spring structure that is rigid in the vertical direction.

2. Device according to claim 1, wherein the first spring structure is rigid in the longitudinal direction and elastic in the transverse direction.

3. Device according to claim 2, wherein the first spring structure comprises a leaf spring arranged parallel to the longitudinal direction and parallel to the vertical direction.

4. Device according to claim 3, wherein the first spring structure comprises a further leaf spring connected to the leaf spring and arranged parallel to the leaf spring.

5. Device according to claim 4, wherein the leaf springs, when viewed in the longitudinal direction, comprise a front end and a rear end, wherein the leaf springs are connected at the front end so as to be bendable towards one another and wherein the first leaf spring is connected at the rear end to the first longitudinal slide and the second leaf spring is connected at the rear end to the third linear rail.

6. Device according to claim 5, wherein the two leaf springs at the rear end comprise a stop directed towards each other for limiting the movement in the transverse direction.

7. Device according to claim 4, wherein the two leaf springs are made of the same material and are geometrically identical.

8. Device according to claim 1, wherein the second spring structure is designed to be elastically torsionable about the vertical direction.

9. Device according to claim 8, comprising a gap extending continuously in the vertical direction between the third linear rail and the second linear slide, said gap being aligned at an entry point in the longitudinal direction and at an exit point in the transverse direction, wherein the torsionable second spring structure comprises at the entry point of the gap a leaf spring aligned in the transverse direction connecting the third linear rail and the second linear slide to each other and at the exit point a leaf spring aligned in the longitudinal direction connecting the third linear rail and the second linear slide to each other.

10. Device according to claim 9, comprising a stop element which is arranged at an angle to the leaf spring aligned in the transverse direction and at an angle to the leaf spring aligned in the longitudinal direction.
